(19) United States
(12) Patent Application Publication
(10) Pub. No.: US 2006/0254533 A1
(43) Pub. Date: Nov. 16, 2006

(54) Dual harness for open tandem vehicle riders

(76) Inventors: Leo G.A. Fuller, Redlands, CA (US); Cheryl V. Fuller, Redlands, CA (US)

Correspondence Address: LITMAN LAW OFFICES, LTD, PO BOX 15035, CRYSTAL CITY STATION, ARLINGTON, VA, 22215, US

(21) Appl. No.: 11/433,477

(22) Filed: May 15, 2006

Related U.S. Application Data
(60) Provisional application No. 60/681,145, filed on May 16, 2005.

(51) Int. Cl. A62B 35/00

(52) U.S. Cl. 119/770

(57) ABSTRACT

The dual harness for open tandem vehicle riders secures the operator and passenger of a two-place open tandem vehicle to one another during operation of the vehicle. The harness is particularly useful for motorcyclists and users of personal watercraft, and is also useful with other open tandem vehicles such as landsailers, iceboats, etc. One embodiment includes a single master waist belt, which encircles both riders, with a separate front belt for the rear rider and rear belt for the front rider. Another embodiment comprises separate waist belts with lateral waist belt connectors therebetween. Each rider is provided with a shoulder harness of either “H” or “Y” configuration, with adjustable left and right shoulder connectors therebetween. All embodiments provide adjustment of the space between riders to allow for different thickness of protective clothing, life vests, etc. as needed, and are adjustable to fit riders from small children to adults.

### CROSS-REFERENCE TO RELATED APPLICATION

This application claims the benefit of U.S. Provisional Patent Application Ser. No. 60/681,145, filed May 16, 2005.

### BACKGROUND OF THE INVENTION

1. Field of the Invention

The present invention relates generally to safety harnesses and belts. More specifically, the present invention comprises various embodiments of a safety harness system in which the rear passenger is adjustably but positively secured to the front passenger or operator of an open tandem vehicle, e.g., a motorcycle, two place personal watercraft, etc.

2. Description of the Related Art

Lightweight, open vehicles of various types have become increasingly popular for personal transportation and for recreation. Motorcycles can be enjoyable to ride under the right conditions and have become increasingly popular due to their fuel and maintenance economies. The same considerations also generally apply to bicycles as well. Motorcycles and bicycles are also quite popular as off-road recreational vehicles, as are smaller two-place watercraft. Even more specialized two place recreational vehicles are experiencing increased interest in various parts of the country where conditions are suitable for their use, such as landsailers in the southwest and ice boats in the northern portions of the country.

Most, if not all, of the above types of vehicles are capable of carrying an operator and a single passenger, with the seating arrangement nearly universally being a tandem configuration. All of the above vehicle types also tend to be open, with no compartment provided to enclose either the operator or the passenger. As such, the rear passenger usually secures himself or herself in place by holding on to the forwardly positioned operator of the vehicle. While this arrangement may provide sufficient safety for a reasonably strong and responsible teen or adult rider, smaller children are at considerably greater risk on such vehicles due to their lack of strength, immaturity, and lack of appreciation for the potential hazards. Even stronger adult passengers can be at some risk in an emergency, as when the vehicle hits a bump, rut, rough water (for a water vehicle), etc. While nearly all states and jurisdictions require protective headgear for both the operator and passenger when riding a motorcycle (as well as certain other types of open vehicles), so-called helmet laws do nothing to ensure that a passenger riding such a vehicle will remain on the vehicle at all times.

Oftentimes motorcyclists will wear relatively bulky protective clothing of leather or other durable material, and watercraft riders nearly universally wear relatively bulky life vests or the like. At other times, such bulky protective gear may not be necessary, depending upon the circumstances, season and temperature, vehicle type, operator and rider characteristics, etc. Consequently, there is a need for a harness for an open tandem vehicle with provision for adjustment for spacing between the operator and passenger

It would further be desirable to have a harness for open tandem vehicles that provides for tethering a relatively small, younger person to an adult vehicle operator, but is also sufficiently adjustable to allow use of the harness by adult riders. Moreover, a harness that can be used with more than one type of open tandem vehicle, e.g., motorcycles and watercraft would be desirable.

Thus, a dual harness for open tandem vehicle riders solving the aforementioned problems is desired.

### SUMMARY OF THE INVENTION

The dual harness for open tandem vehicle riders generally comprises an adjustable waist belt system that completely encircles both the front and rear riders of an open tandem vehicle (e.g., motorcycle, personal watercraft, etc.). The master belt may be formed as a single, unitary belt or as a pair of separate waist belts with lateral connecting straps on each side. The unitary belt includes at least partial separate waist belts for both riders, with the separate belts attaching to the master belt. Both embodiments provide adjustment for the spacing of the separate waist belts between the two riders, as well as handles for the rear passenger at the back of the front waist belt.

The waist belt assembly for each rider is provided with a shoulder harness assembly, with each shoulder harness comprising either an “H” configuration (i.e., two forward and two rearward straps joining the waist belt) or a “Y” configuration (i.e., a single rearward strap joining the waist belt). All embodiments also include left and right shoulder harness connector straps to secure the two riders together at their shoulders, with the shoulder harness connector straps also being adjustable in length to accommodate variable spacing requirements between riders. The rear passenger belt assembly is also preferably provided with a crotch strap for even greater security for younger and smaller riders.

These and other features of the present invention will become readily apparent upon further review of the following specification and drawings.

### BRIEF DESCRIPTION OF THE DRAWINGS

FIG. 1 is an environmental, perspective view of a first embodiment of a dual harness for open tandem vehicle riders according to the present invention, showing its use by two motorcycle riders.

FIG. 2 is an environmental, perspective view of a second embodiment dual harness for open tandem vehicle riders according to the present invention, showing its use by two watercraft riders.

FIG. 3 is an exploded perspective view of a single master belt and “H” shoulder harness embodiment of the harness of FIG. 1, showing details thereof.

FIG. 4 is an exploded perspective view of the dual waist belt and interconnecting strap embodiment of FIG. 2 having “Y” shoulder harnesses, showing details thereof.

Similar reference characters denote corresponding features consistently throughout the attached drawings.

### DETAILED DESCRIPTION OF THE PREFERRED EMBODIMENTS

The present invention comprises various embodiments of a dual harness for open tandem vehicle riders that secure the rear rider or passenger to the front rider or operator of the vehicle. The harness is adjustable in numerous ways, and can accommodate different riders and operators ranging from small children to adults, and also allows for variable spacing between the two riders and/or permits adjustment for bulky and/or protective clothing, etc.

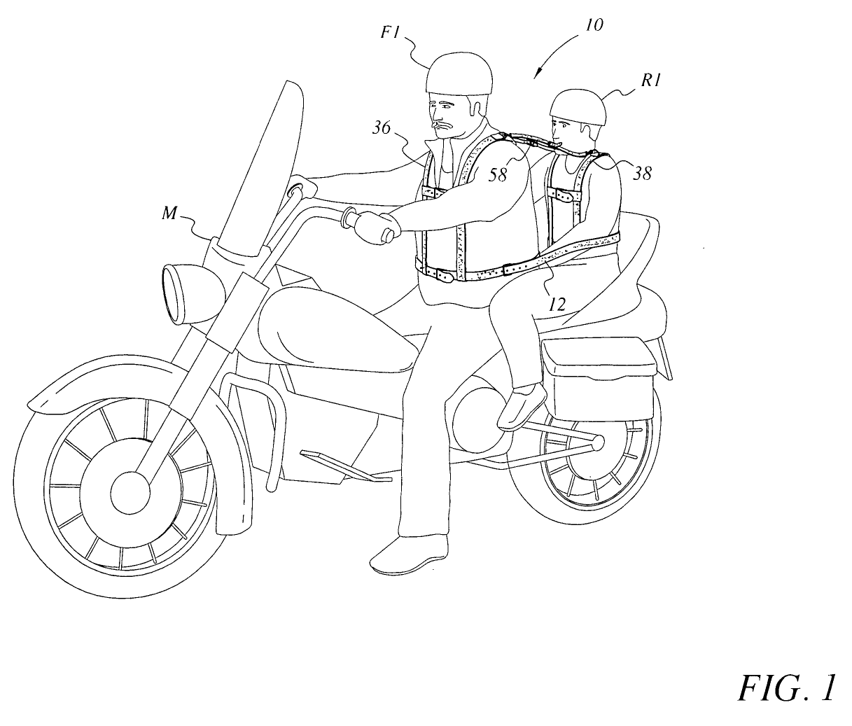

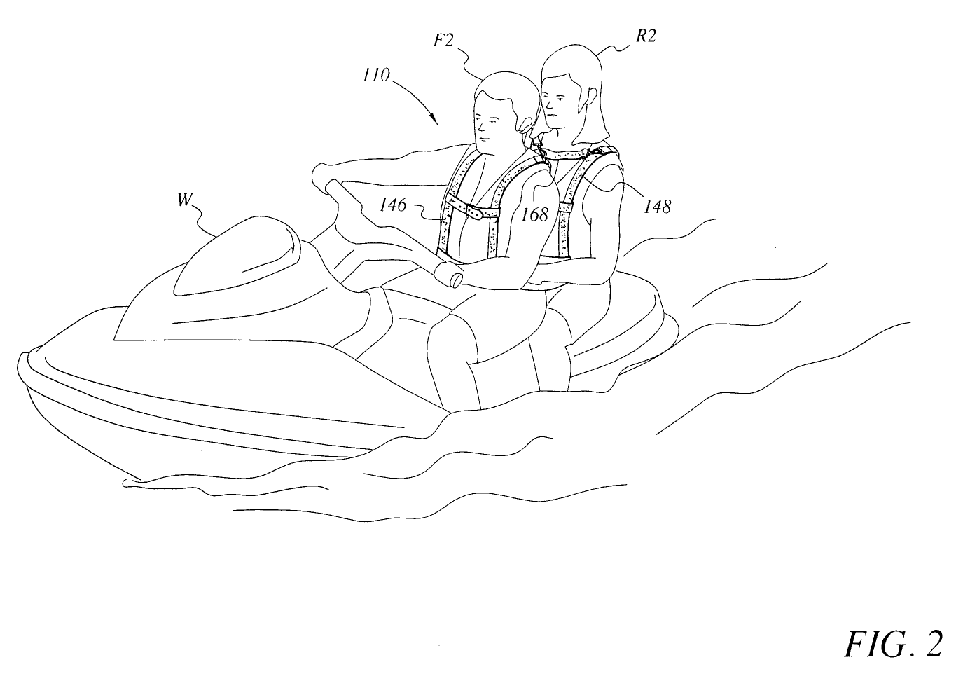

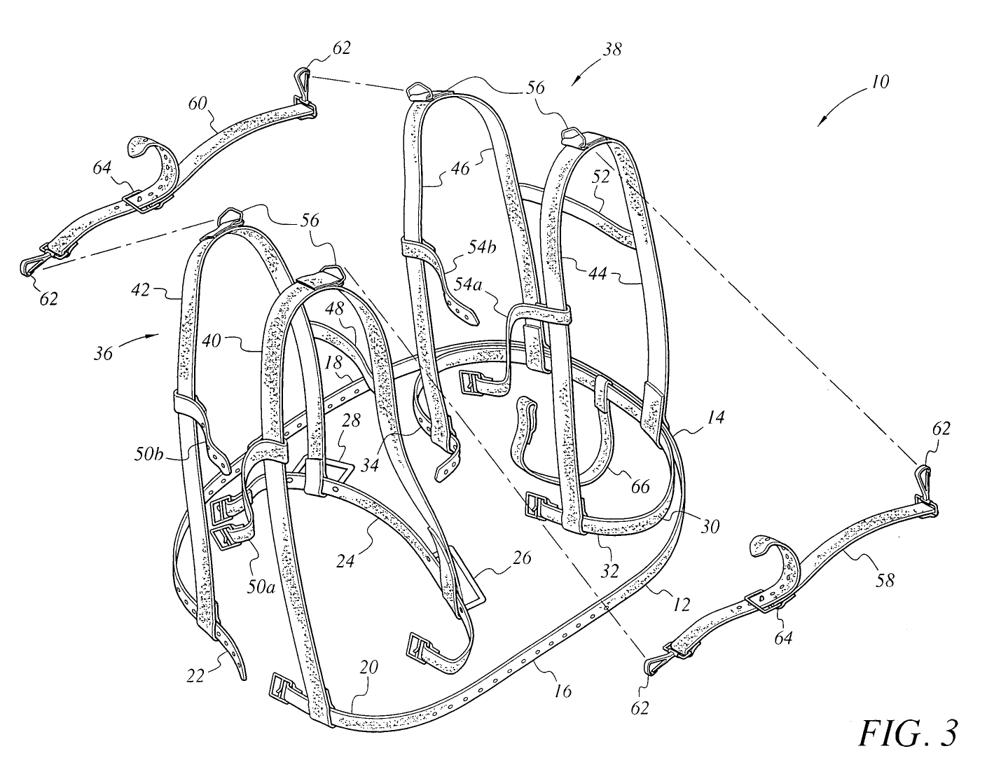

FIG. 1 provides an environmental view of a first embodiment harness 10 being worn by a forward rider or operator F1 and a rear rider or passenger R1 on a motorcycle M. This harness 10 is shown in detail in the exploded perspective view of FIG. 3. In FIG. 2, a forward rider or operator F2 and a rear rider or passenger R2 are shown wearing a second embodiment harness 110 of the present invention while riding a personal watercraft W. It will be appreciated that either harness embodiment may be used with either type of vehicle, or with other open tandem vehicles, and that various details of the different harnesses 10 and 100 may be interchanged between the two.

The first harness embodiment 10 of FIGS. 1 and 3 comprises a single, continuous two-person waist belt 12 having a rear portion 14 with left and right lateral portions 16 and 18 extending from the rear portion, and left and right connector end portions 20 and 22 extending from the respective left and right lateral portions 16 and 18 to provide an adjustable closure for the front rider or operator. A conventional buckle, as shown, or other means of securing the two end portions 16 and 18 (e.g., side latch buckles, cam gripping latches, etc.) may be used as desired.

A front rider dorsal belt component 24 is provided for the front rider, and extends across the two lateral portions 16 and 18 of the two person or master belt 12 to pass closely about the back of the waist of the front rider, essentially serving the same function as the back portion of a conventional waist belt. The dorsal belt 24 secures to the two lateral portions 16 and 18 of the two person master belt 12 by conventional buckles (as shown in FIG. 3) or other conventional fastener means. A plurality of adjustment holes are provided along the lateral portions 16 and 18 of the master belt 12 for adjusting the position of the dorsal belt component 24 relative to the rear portion 14 of the master belt 12. This allows the spacing between the front and rear riders to be adjusted as required to accommodate different seating arrangements, different thickness of protective clothing, different rider sizes, etc. The dorsal belt component 24 also includes a pair of handles 26 and 28 extending therefrom to provide further security for the rear rider or passenger, although it will be understood that the interconnected belt assembly of the present invention is the primary means of securing the rear rider to the front rider.

A rear rider waist belt 30 is adjustably secured to the rear portion 14 of the two person master belt 12, e.g., by passing through shoulder harness attachment loops, as shown. The rear rider waist belt 30 includes left and right connector end portions, respectively 32 and 34, extending therefrom, with the end portions providing an adjustable rear rider closure for the rear rider waist belt 30. The rear rider waist belt 30 serves to secure the rear rider, while the connector end portions 20 and 22 of the master belt 12, along with the forward parts of the lateral portions 16 and 18 thereof and the dorsal belt component 24, secure the front rider. The front and rear riders are secured to one another at their waists by the lateral portions 16 and 18 of the master belt 12.

Further means of securing the two riders to one another is provided by the shoulder harness assembly of the present harness invention. Two shoulder harness assemblies are provided, i.e., a front rider shoulder harness assembly 36 and a rear rider shoulder harness assembly 38. The front rider shoulder harness assembly 36 comprises separate, laterally spaced left and right shoulder straps, respectively 40 and 42, which extend from their attachment loops along the dorsal belt component 24 to pass up and over the shoulders of the front rider and attach to the left and right connector end portions 20 and 22 of the master belt 12. The rear rider shoulder harness assembly 38 comprises separate, laterally spaced left and right shoulder straps, respectively 44 and 46, which extend from their attachment loops along the rear portion 14 of the master belt 12 and/or the back of the rear rider waist belt 30 to pass up and over the shoulders of the rear rider and attach to the left and right connector end portions 32 and 34 of the rear rider waist belt 30.

Both shoulder harness assemblies 36 and 38 may secure to the waist belts at their respective attach points by means of closed loops formed in the ends of the shoulder straps through which the waist belts pass, as shown in FIG. 3, or other conventional means as desired. The lengths of the various shoulder straps 40 through 46 may be adjusted by means of conventional buckles, as shown with the connector end 20 of the master belt 12 and connector end 32 of the rear rider waist belt 30, or other conventional means as desired. Such adjustment means are not shown in FIG. 3 in order to provide greater clarity in the drawing. An additional rear lateral strap 48 extends across the rear portions of the two front rider shoulder straps 40 and 42, with front lateral strap segments 50a and 50b extending from the front portions of the respective front rider shoulder straps 40 and 42. Essentially the same configuration is provided for the rear rider harness assembly 38 by a rear lateral strap 52 and front lateral strap segments 54a and 54b. The front lateral strap segments 50a, 50B and 54a, 54b secure across the chest of the respective rider by means of conventional adjustable buckle attachments, as shown in FIG. 3, or by other conventional means.

Each of the shoulder harness straps 40 through 46 includes a D-ring 56 or the like at or near its apex. These D-ring attachments 56 provide for the attachment of left and right shoulder harness connector strap assemblies, respectively 58 and 60, across the respective left front and left rear shoulder harness straps 40 and 44 and right front and right rear shoulder harness straps 42 and 46. The two shoulder harness connector straps may be secured to the D-rings 56 by means of snap links 62 at their ends; alternative attachment means may be provided as desired. Each of the shoulder harness connector straps 58 and 60 includes an adjustment buckle 64 or the like. The buckles 64 may be identical to the buckles used to connect various other straps together in the present harness assembly 10. Other conventional buckle configurations may be used as desired.

Even greater security may be provided for the rear rider, particularly for smaller rear riders, by means of a crotch strap 66. The crotch strap 66 extends from the rear portion 14 of the master belt 12, and/or the rear portion of the rear rider waist belt 30, and passes between the upper legs or thighs of the rear rider. The forward end of the crotch strap 66 may terminate in a loop, which is passed over one of the connector ends 32 or 34 of the rear rider waist belt 30 before the ends 32 and 34 are secured together about the waist of the rear rider.

The dual harness 10 is used by first fitting the rear rider waist belt 30 about the rear rider or passenger, and adjustably connecting the two rear rider belt ends 32 and 34 about the waist of the rear rider to provide a good fit. The crotch strap 66 is assembled with the ends 32 and 34 of the rear rider belt 30 before the ends are connected to one another. The rear shoulder harness straps 44 and 46 may then be adjusted to fit the rear passenger, with the front lateral strap assemblies 54a, 54b being secured at this time. At this point, the rear rider may be seated on the vehicle (e.g., motorcycle M of FIG. 1, watercraft W of FIG. 2, or other open tandem vehicle).

The distance or spacing between the rear passenger or rider and the front rider or operator is determined and the front rider dorsal belt 24 is positioned between the sides 16 And 18 of the two person master belt 12, the lengths of the shoulder harness connector straps 58 and 60 are adjusted, and the shoulder harness connectors 58 and 60 are secured to their respective shoulder harness D rings 56. (The shoulder harness connector straps 58 and 60 may be secured diagonally across the two shoulder harness assemblies 38 and 42, if so desired, i.e., one connector strap extending between the left front and right rear shoulder straps 40 and 46, and the other connector strap extending between the right front and left rear shoulder straps 42 and 44.)

The front rider or operator may then mount the vehicle and secure himself or herself in the harness by securing the two connector end portions 20 and 22 of the two person belt 12 and securing the two lateral strap portions 50a, 50b of the forward shoulder harness assembly 36 to one another. This completes the assembly of the two-person harness 10, and assures that the rear rider cannot fall from the vehicle so long as the front rider or operator remains with the vehicle.

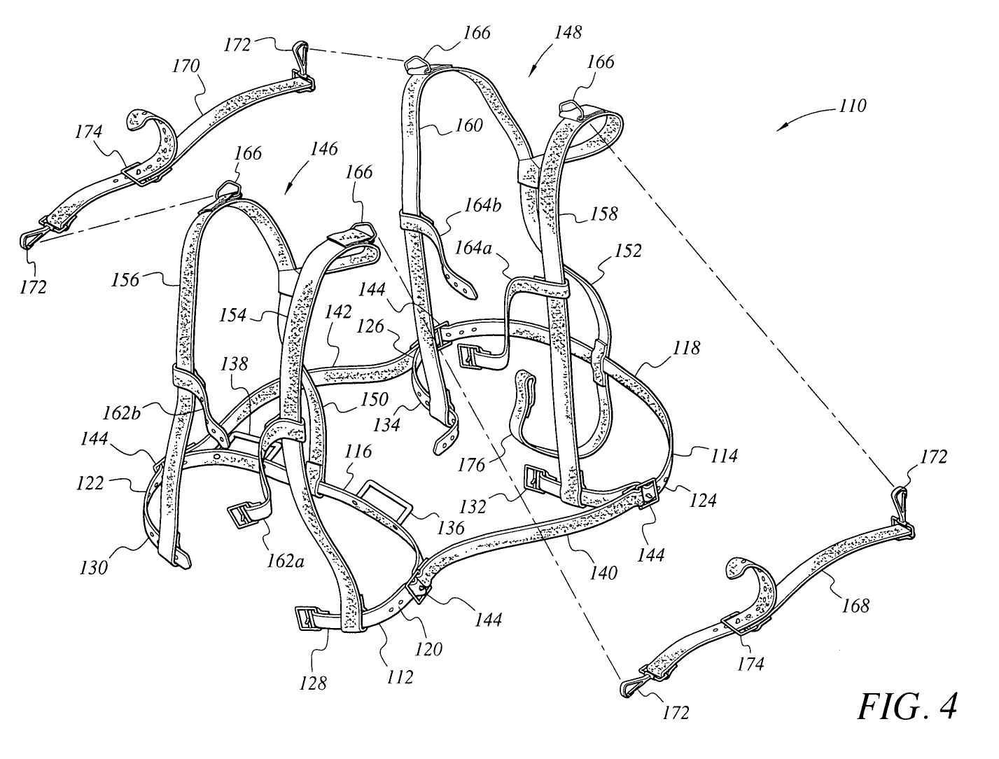

FIG. 2 provides an environmental perspective view of two riders F2 and R2 operating a personal watercraft W while wearing an alternative embodiment 110 of the dual harness, while FIG. 4 provides a detailed exploded perspective view of the harness 110. The second harness embodiment 110 of FIGS. 2 and 4 includes two separate waist belts for the front and rear riders, respectively front waist belt 112 and rear waist belt 114. Each waist belt 112 and 114 includes a dorsal portion, respectively 116 for the front rider belt 112, and 118 for the rear rider belt 114, and left and right lateral portions, respectively 120 and 122 for the front belt 112, and 124, 126 for the rear belt 114. Each belt further includes left and right end connector portions, respectively 128 and 130 for the front belt 112, and 132, 134 for the rear belt 114. The respective end connectors 128, 130 and 132, 134 secure adjustably and conventionally to close the respective belts 112 and 114 about the waists of the front and rear riders. The dorsal portion 116 of the front rider waist belt 112 also includes a pair of handles 136 and 138 extending therefrom to provide further security for the rear rider or passenger, similarly to the rear rider handles 26 and 28 of the dual rider harness assembly 10 of FIGS. 1 and 2.

The front rider and rear rider waist belts 112 and 114 are secured to one another by left and right lateral waist belt connector straps, respectively 140 and 142, which attach adjustably between the two rider waist belts. The ends 144 of the waist belt connector straps 140 and 142 are equipped with buckles (or other suitable adjustable attachment means) which selectively engage a plurality of adjustment holes provided along the lateral portions 120 through 126 of the two belts 112 and 114. This allows the spacing between the front and rear riders to be adjusted as required to accommodate different seating arrangements, different thickness of protective clothing, different rider sizes, etc. The lengths of the two lateral waist belt connector straps 140 and 142 may be made to be adjustable by means of conventional buckles, etc. (not shown for clarity in the drawing Fig.), if so desired.

Further means of securing the two riders to one another is provided by the shoulder harness assembly. Two shoulder harness assemblies are provided for the dual harness assembly 110 of FIGS. 2 and 4, i.e., a front rider shoulder harness assembly 146 and a rear rider shoulder harness assembly 148. The two shoulder harness assemblies 146 and 148 differ from the shoulder harness assemblies 36 and 38 of the harness embodiment 10 of FIGS. 1 and 3, with the shoulder harness assemblies 146 and 148 having a general “Y” configuration while the shoulder harness assemblies 36 and 38 have a general “H” configuration.

Each shoulder harness assembly 146 and 148 comprises a single back strap, respectively 150 and 152, which extends from the dorsal or rear portion, respectively 116 and 118, of the respective front or rear waist belt 112 and 114. Left and right shoulder straps, respectively 154 and 156 for the front shoulder harness assembly 146 and 158 and 160 for the rear assembly 148, extend from their respective single back straps 150 and 152 to join the waist belt connector ends, i.e., front belt connector ends 128 and 130 for the front shoulder harness shoulder straps 154 and 156, and rear belt connector ends 132 and 134 for the rear shoulder harness shoulder straps 158 and 160. The shoulder straps 154 through 160 may include means for adjusting their lengths, as in the case of the shoulder straps of the harness embodiment 10 of FIGS. 1 and 3, and front lateral strap assemblies, respectively 162a, 162b for the front shoulder harness assembly 146 and 164a, 164b for the rear shoulder harness assembly 148.

It will be seen that either type of shoulder harness assembly, i.e., the “H” strap configuration of the shoulder harnesses 36 and 38 of the harness embodiment 10 of FIGS. 1 and 3, or the “Y” strap configuration of the shoulder harnesses 146 and 148 of FIGS. 2 and 4, may be used interchangeably with either type of waist belt configuration as desired.

Each of the shoulder harness straps 154 through 160 includes a D-ring 166 or the like at or near its apex. These D-ring attachments 166 provide for the attachment of left and right shoulder harness connector strap assemblies, respectively 168 and 170, across the respective left front and left rear shoulder harness straps 154 and 156 and right front and right rear shoulder harness straps 158 and 160. The two shoulder harness connector straps secure to the D-rings 166 by means of snap links 172 at their ends; alternative attachment means may be provided as desired. Each of the shoulder harness connector straps 168 and 170 includes an adjustment buckle 174 or the like. The buckles 174 may be identical to the buckles used to connect various other straps together in the present harness assembly 10. Other conventional buckle configurations may be used as desired.

Even greater security may be provided for the rear rider, particularly for smaller rear riders, by means of a crotch strap 176. The crotch strap 176 extends from the rear or dorsal portion 118 of the rear rider waist belt 114, and passes between the upper legs or thighs of the rear rider. The forward end of the crotch strap 176 may terminate in a loop, which is passed over one of the connector ends 132 or 134 of the rear rider waist belt 114, before the ends 32 and 34 are secured together about the waist of the rear rider.

The dual harness 110 is installed to the riders in a somewhat different manner than the dual harness 10 of FIGS. 1 and 3, due to the separable waist belts 112 and 114 for the two riders. Each rider may initially install his or her waist belt 112 and 114 as desired, and adjust the corresponding shoulder harness assembly 146 and 148 for proper fit. This may be accomplished separately and independently by each rider, as the connection means for the two rider harnesses comprises a series of separate connector straps. The crotch strap 176 is assembled with the ends 132 and 134 of the rear rider belt 114 before the ends are connected to one another. Once the two riders have donned their respective waist belts and shoulder harness assemblies, they may determine the approximate spacing required to ride the vehicle (motorcycle, watercraft, etc.) and secure the waist belt connector straps 140 and 142 and the shoulder harness connector straps 168 and 170 to one of the two waist belts 112 or 114 and shoulder harness assemblies 146 or 148.

At this point, the two riders may mount the vehicle and complete the connector strap installation to the remaining belt and shoulder harness assembly. (The shoulder harness connector straps 168 and 170 may be secured diagonally across the two shoulder harness assemblies 146 and 148, if so desired, i.e., one connector strap extending between the left front and right rear shoulder straps 154 and 160, and the other connector strap extending between the right front and left rear shoulder straps 156 and 158, if so desired.) Final adjustments of the connector straps may be accomplished at this time, as required. This completes the assembly of the present two-person harness 110, and assures that the rear rider cannot fall from the vehicle so long as the front rider or operator remains with the vehicle.

In conclusion, the two-person harness system, in any of its embodiments, greatly improves passenger or rider security on an open two-place tandem vehicle. While the device is particularly valuable for motorcyclists, it will be seen that it is also valuable for use with personal watercraft and other motorsports vehicles, as well as unpowered two place tandem vehicles such as bicycles and certain landsailers and iceboats having two place tandem rider configurations. The various alternative components of the harness system may be combined in different combinations with one another as desired, e.g., the “H” shoulder harness configuration of the embodiment of FIGS. 1 and 3 may be used with the separate waist belt of the embodiment of FIGS. 2 and 4, with the “Y” shoulder harness configuration of FIGS. 2 and 4 being adaptable to the master waist belt configuration of FIGS. 1 and 3. The adaptability and versatility of the dual harness system in its various embodiments provides security for passengers of two place tandem open vehicles regardless of the passenger's age, size, physical strength, and/or riding skill. Accordingly, the harness system will prove to be a most useful and desirable addition to the equipment of motorcyclists, bicyclists, watercraft enthusiasts, and others who engage in the operation of two place tandem open vehicles.

It is to be understood that the present invention is not limited to the embodiments described above, but encompasses any and all embodiments within the scope of the following claims.

We claim:

1. A dual harness for open tandem vehicle riders, comprising:
a two person tandem waist belt assembly having a front rider dorsal belt component extending thereacross; and
first and second rear rider handgrips extending from the front rider dorsal belt component.

2. The dual harness for open tandem vehicle riders according to claim 1, further including a front rider shoulder harness assembly and a rear rider shoulder harness assembly, the shoulder harness assemblies extending from said tandem waist belt assembly.

3. The dual harness for open tandem vehicle riders according to claim 2, further including at least one lateral strap extending across each said shoulder harness assembly.

4. The dual harness for open tandem vehicle riders according to claim 2, wherein:
said two person tandem waist belt assembly further includes a rear portion, left and right rear rider connector end portions extending respectively from the rear portion and forming an adjustable rear rider closure, left and right lateral portions extending from the rear portion, and left and right front rider connector end portions extending respectively from the left and right lateral portions and forming an adjustable front rider closure;
said front rider shoulder harness assembly comprises a left shoulder strap and a right shoulder strap, each of the shoulder straps extending from the front rider dorsal belt component of said two person, tandem waist belt assembly to the respective left and right front rider connector end portions thereof; and
said rear rider shoulder harness assembly comprises a left shoulder strap and a right shoulder strap, each of the shoulder straps extending from the rear portion of said two person, tandem waist belt assembly to the respective left and right rear rider connector end portions thereof.

5. The dual harness for open tandem vehicle riders according to claim 2, wherein:
said two person tandem waist belt assembly further includes a rear portion, left and right rear rider connector end portions extending respectively from the rear portion and forming an adjustable rear rider closure, left and right lateral portions extending from the rear portion, and left and right forward rider connector end portions extending respectively from the left and right lateral portions and forming an adjustable front rider closure;
said front rider shoulder harness assembly comprises a single back strap extending from the front rider dorsal belt component of said two person tandem waist belt assembly, a left shoulder strap, and a right shoulder strap, the shoulder straps extending from the back strap to the respective left and right front rider connector end portions of said two person tandem waist belt assembly; and
said rear rider shoulder harness assembly comprises a single back strap extending from the from the rear portion of said two person tandem waist belt assembly, a left shoulder strap, and a right shoulder strap, the shoulder straps extending from the back strap to the respective left and right rear rider connector end portions of said two person tandem waist belt assembly.

6. The dual harness for open tandem vehicle riders according to claim 1, wherein said two person tandem waist belt assembly further includes:
a rear portion, left and right lateral portions extending from the rear portion, and left and right connector end portions extending respectively from the left and right lateral portions and forming an adjustable front rider closure, the front rider dorsal belt component adjustably extending between the left and right lateral portions of said two person tandem waist belt assembly;
a rear rider waist belt adjustably secured to the rear portion of said two person tandem waist belt assembly, the rear rider waist belt further including left and right connector end portions and forming an adjustable rear rider closure;
a front rider shoulder harness assembly extending from said front rider dorsal belt component to the left and right connector end portions of said two person tandem waist belt assembly;
a rear rider shoulder harness assembly extending from the rear portion of said two person tandem waist belt assembly to the connector end portions of said rear rider waist belt; and
a left and a right shoulder harness connector adjustably extending between said front rider shoulder harness assembly and said rear rider shoulder harness assembly.

7. The dual harness for open tandem vehicle riders according to claim 1, wherein said two person tandem waist belt assembly further includes:
a front rider waist belt with the dorsal belt component thereof having left and right lateral portions extending therefrom, left and right connector end portions extending respectively from the left and right lateral portions and forming an adjustable front rider closure;
a rear rider waist belt having a rear portion with left and right lateral portions extending therefrom, and left and right connector end portions extending respectively from the left and right lateral portions and forming an adjustable rear rider closure;
left and right waist belt connector straps adjustably disposed between the front rider waist belt and the rear rider waist belt;
a front rider shoulder harness assembly extending from the dorsal belt component of the front rider waist belt to the connector end portions of the front rider waist belt;
a rear rider shoulder harness assembly extending from the rear portion of the rear rider waist belt to the connector end portions of the rear rider waist belt; and
a left and a right shoulder harness connector adjustably extending between the front rider shoulder harness assembly and the rear rider shoulder harness assembly.

8. The dual harness for open tandem vehicle riders according to claim 1, wherein said two person tandem waist belt assembly further includes a rear portion, left and right rear rider connector end portions extending respectively from the rear portion and forming an adjustable rear rider closure, the dual harness further comprising a rear rider crotch strap extending from the rear portion of said two person tandem waist belt assembly and attaching selectively to the rear rider connector end portions thereof.

9. A dual harness for open tandem vehicle riders, comprising:
a two person tandem waist belt assembly having a rear portion, left and right lateral portions extending from the rear portion, and left and right connector end portions extending respectively from the left and right lateral portions and forming an adjustable front rider closure;
a rear rider waist belt adjustably secured to the rear portion of the two person tandem waist belt assembly, the rear rider waist belt having left and right connector end portions and forming an adjustable rear rider closure;
a front rider dorsal belt component adjustably extending between the left and right lateral portions of the two-person tandem waist belt assembly;
a rear rider shoulder harness assembly extending from the rear portion of the two-person tandem waist belt assembly to the connector end portions of the rear rider waist belt;
a front rider shoulder harness assembly extending from the front rider dorsal belt to the left and right connector end portions of the two person tandem waist belt assembly; and
a left and a right shoulder harness connector adjustably extending between the front rider shoulder harness assembly and the rear rider shoulder harness assembly.

10. The dual harness for open tandem vehicle riders according to claim 9, further including first and second rear rider hand grips extending from the front rider dorsal belt component.

11. The dual harness for open tandem vehicle riders according to claim 9, further including at least one lateral strap extending across each said shoulder harness assembly.

12. The dual harness for open tandem vehicle riders according to claim 9, wherein:
said front rider shoulder harness assembly comprises a left shoulder strap and a right shoulder strap, each of the shoulder straps extending from the front rider dorsal belt component of said two person tandem waist belt assembly to the respective left and right connector end portions of the left and right lateral portions thereof; and
said rear rider shoulder harness assembly comprises a left shoulder strap and a right shoulder strap, each of the shoulder straps extending from the rear portion of said two person tandem waist belt assembly to the respective left and right connector end portions of said rear rider waist belt.

13. The dual harness for open tandem vehicle riders according to claim 9, wherein:
said front rider shoulder harness assembly comprises a single back strap extending from the front rider dorsal belt component of said two person tandem waist belt assembly, a left shoulder strap, and a right shoulder strap, the shoulder straps extending from the back strap to the respective left and right connector end portions of the left and right lateral portions of said two person tandem waist belt assembly; and
said rear rider shoulder harness assembly comprises a single back strap extending from the from the rear portion of said two person tandem waist belt assembly, a left shoulder strap, and a right shoulder strap, the shoulder straps extending from the back strap to the respective left and right connector end portions of said rear rider waist belt.

14. The dual harness for open tandem vehicle riders according to claim 9, further including a rear rider crotch strap extending from the rear rider waist belt and attaching selectively to the connector end portions thereof.

15. A dual harness for open tandem vehicle riders, comprising:
a front rider waist belt having a dorsal portion with left and right lateral portions extending therefrom, and with left and right connector end portions extending respectively from the left and right lateral portions and forming an adjustable front rider closure;
a rear rider waist belt having a rear portion with left and right lateral portions extending therefrom, and with left and right connector end portions extending respectively from the left and right lateral portions and forming an adjustable rear rider closure;
a left and a right waist belt connector strap adjustably disposed between the front rider waist belt and the rear rider waist belt;
a front rider shoulder harness assembly extending from the rear portion of the front rider waist belt to the connector end portions of the front rider waist belt;
a rear rider shoulder harness assembly extending from the rear portion of the rear rider waist belt to the connector end portions of the rear rider waist belt; and
a left and a right shoulder harness connector adjustably extending between the front rider shoulder harness assembly and the rear rider shoulder harness assembly.

16. The dual harness for open tandem vehicle riders according to claim 15, further including first and second rear rider hand grips extending from the dorsal portion of said front rider waist belt.

17. The dual harness for open tandem vehicle riders according to claim 15, further including at least one lateral strap extending across each said shoulder harness assembly.

18. The dual harness for open tandem vehicle riders according to claim 15, wherein:
said front rider shoulder harness assembly comprises a left shoulder strap and a right shoulder strap, each of the shoulder straps extending from the dorsal portion of said forward rider waist belt to the respective left and right connector end portions thereof; and
said rear rider shoulder harness assembly comprises a left shoulder strap and a right shoulder strap, each of the shoulder straps extending from the rear portion of said rear rider waist belt to the respective left and right connector end portions thereof.

19. The dual harness for open tandem vehicle riders according to claim 15, wherein:
said front rider shoulder harness assembly comprises a single back strap extending from the dorsal portion of said front rider waist belt, a left shoulder strap, and a right shoulder strap, the shoulder straps extending from the back strap to the respective left and right connector end portions thereof; and
said rear rider shoulder harness assembly comprises a single back strap extending from the rear portion of said rear rider waist belt, a left shoulder strap and a right shoulder strap, the shoulder straps extending from the back strap to the respective left and right connector end portions thereof.

20. The dual harness for open tandem vehicle riders according to claim 15, further including a rear rider crotch strap extending from the rear rider waist belt and attaching selectively to the connector end portions thereof.
